(19) United States
(12) Patent Application Publication
(10) Pub. No.: US 2013/0050183 A1
(43) Pub. Date: Feb. 28, 2013

(54) System and Method of Rendering Stereoscopic Images

(71) Applicant: Tzung-Ren WANG, Tainan City (TW)

(72) Inventor: Tzung-Ren WANG, Tainan City (TW)

(73) Assignee: HIMAX TECHNOLOGIES LIMITED, Tainan City (TW)

(21) Appl. No.: 13/217,560

(22) Filed: Aug. 25, 2011

(51) Int. Cl. G06T 15/00

(52) U.S. Cl. 345/419

(57) ABSTRACT

A method of rendering stereoscopic images comprises providing a first image of a scene having a first pixel resolution, and a second image of the same scene having a second pixel resolution different from the first pixel resolution, forming an image frame that assembles the first image of the first pixel resolution with the second image of the second pixel resolution, and transmitting the image frame to an image processing unit. In other embodiments, a system of rendering stereoscopic images is also described.

### BACKGROUND

1. Field of the Invention

The present invention relates to systems and method of rendering stereoscopic images

2. Description of the Related Art

For increased realism, three-dimensional (3D) stereoscopic image technology is increasingly applied in various fields such as broadcasting, gaming, animation, virtual reality, etc. The stereoscopic vision perceived by a human being is mainly caused by the binocular disparity created by the lateral distance between the left eye and right eye. Due to binocular disparity, the left eye and the right eye can receive an image of a same scene under two different perspective views. The brain then can combine these two images to create the depth sense of the 3D stereoscopic vision.

To create a stereoscopic perception in image rendering, two sets of images are typically captured or generated to simulate the left eye view and right eye view. When these two images are displayed on a two-dimensional screen, a specific viewing apparatus (e.g., viewing glasses) can be used to separate the two images, so that each of the left and right eyes can only see the image associated therewith. The brain can then recombine these two different images to produce the depth perception.

Because the amount of images to process is at least doubled, the required processing tasks and computation is increased. As a result, the stereoscopic pair of images may need to be compressed to be transmitted in an efficient way. However, the current approaches mostly propose systematic compression schemes (e.g., side-by-side or top-bottom) which may more or less affect the final depth rendering. Therefore, one challenge is to efficiently process the increased amount of image data with limited hardware capabilities, and yet provide effective depth rendering.

### SUMMARY

The present application describes a system and method of rendering stereoscopic images. According to one embodiment, a method of rendering stereoscopic images comprises providing a first image of a scene having a first pixel resolution, and a second image of the same scene having a second pixel resolution different from the first pixel resolution, forming an image frame that assembles the first image of the first pixel resolution with the second image of the second pixel resolution, and transmitting the image frame to an image processing unit.

In another embodiment, a system of rendering stereoscopic images is described. The system comprises a memory, and a processing unit configured to: receive a first image and a second image of a same scene respectively at a same initial pixel resolution, scale down the first image from the initial pixel resolution to a first pixel resolution, scale down the second image from the initial pixel resolution to a second pixel resolution different from the first pixel resolution, generate an image frame that assembles the first image of the first pixel resolution with the second image of the second pixel resolution according to a first format, and process the image frame to synthesize a first stereoscopic image.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a schematic diagram illustrating one embodiment of a stereoscopic image rendering system;

FIG. 2A is a schematic diagram illustrating a first format of an image frame that can be generated by the image formatter unit shown in FIG. 1;

FIG. 2B is a schematic diagram illustrating a second format of an image frame that can be generated by the image formatter unit;

FIG. 2C is a schematic diagram illustrating a third format of an image frame that can be generated by the image formatter unit;

FIG. 2D is a schematic diagram illustrating a fourth format of an image frame that can be generated by the image formatter unit;

FIG. 2E is a schematic diagram illustrating a fifth format of an image frame that can be generated by the image formatter unit;

FIG. 2F is a schematic diagram illustrating a sixth format of an image frame that can be generated by the image formatter unit;

FIG. 2G is a schematic diagram illustrating a seventh format of an image frame that can be generated by the image formatter unit;

FIG. 2H is a schematic diagram illustrating an eighth format of an image frame that can be generated by the image formatter unit;

FIG. 3 is a flowchart of method steps for generating a stereoscopic image according to an embodiment of the present invention; and

FIG. 4 is a flowchart of method steps for generating stereoscopic images according to another embodiment of the present invention.

### DETAILED DESCRIPTION OF EMBODIMENTS

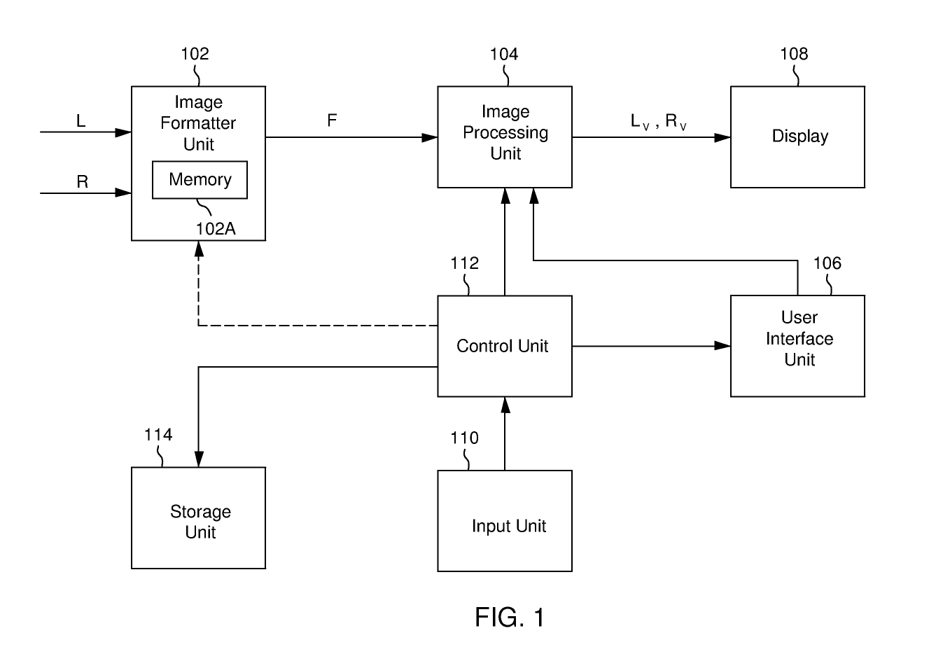

FIG. 1 is a simplified diagram illustrating one embodiment of a stereoscopic image rendering system 100. The system 100 can include an image formatter unit 102, an image processing unit 104, a user interface unit 106, a display device 108, an input unit 110, a control unit 112, and a storage unit 114. The image formatter unit 102, the image processing unit 104, the user interface unit 106 and the control unit 112 can be formed as separate and distinct processing units, or integrated into one or more processing units according to the hardware design. In some embodiments, the image formatter unit 102, the image processing unit 104, the user interface unit 106, the control unit 112 and the storage unit 114 can be integrated into a multimedia apparatus, such as smart-phones, tablet computers, portable computers and the like. In other embodiments, the image processing unit 104, the user interface unit 106, the control unit 112 and the storage unit 114 can be integrated into a receiver device, (e.g., a 3D television set), and the image formatter unit 102 can be provided at a source device.

The image formatter unit 102 can be formed as a processing unit coupled with a memory 102A. The image formatter unit 102 can receive stereoscopic pairs of images L and R from a content provider device (not shown), generate image frames F that assemble and encapsulate each stereoscopic pair of images into an image frame F, and transmit the image frames F to the image processing unit 104. Examples of the content provider device can include an image capturing apparatus (e.g., camera), a 3D image generating apparatus, and the like. The images inputted to the image formatter unit 102 can include a stereoscopic pair of a left-view image L and a right-view image R that represent a same scene from left-eye and right-eye perspectives.

These image frames F may be transmitted from the image formatter unit 102 to the image processing unit 104 through wireless connection, or wired connection such as High Definition Multimedia Interface (HDMI), Digital Visual Interface (DVI), S-Video interface, and the like. The image processing unit 104 can receive the image frames F from the image formatter unit 102, extract left-view and right-view images from the image frames F, scale up and/or interpolate the extracted images, and apply various computation and conversion to generate a stereoscopic pair of left-view and right-view images Lᵥ and Rᵥ to be shown on the display device 108.

In one embodiment, the image processing unit 104 may comprise multiple modules through which the image data can be processed to generate the left-view and right-view images Lᵥ and Rᵥ. These modules can include, without limitation, a depth map extraction unit adapted to compute depth maps associated with the left-view and right-view images, and a 3D rendering engine adapted to form the left-view and right-view images Lᵥ and Rᵥ based on the extracted left-view and right-view images and the depth map.

The user interface unit 106 can generate and send a graphic user interface to the image processing unit 104 to be shown on the display device 108. The graphic user interface may typically include graphic and textual content that allows the user to interact with the system 100.

The input unit 110 can include a remote controller, a keyboard, and/or buttons disposed on the display device 108. In other embodiments, the input unit 110 can also be provided as a touch panel integrated with the display device 108. Through the input unit 110, the user can input instructions/selections to the system 100.

In one embodiment, the control unit 112 can be connected with the image processing unit 104, the user interface unit 106, the input unit 110 and the storage unit 114 to supervise the operations of these units. In another embodiment, the control unit 112 may also be connected with the image formatter unit 102 (shown with dotted lines), and can be adapted to control the image formatter unit 102 for modifying the format of the image frame F outputted by the image formatter unit 102.

The storage unit 114 can be used to store various image data processed by the system 100 which can include, without limitation, the left-view and right-view images L and R inputted to the image formatter unit, and image data of the image frames F generated by the image formatter unit 102.

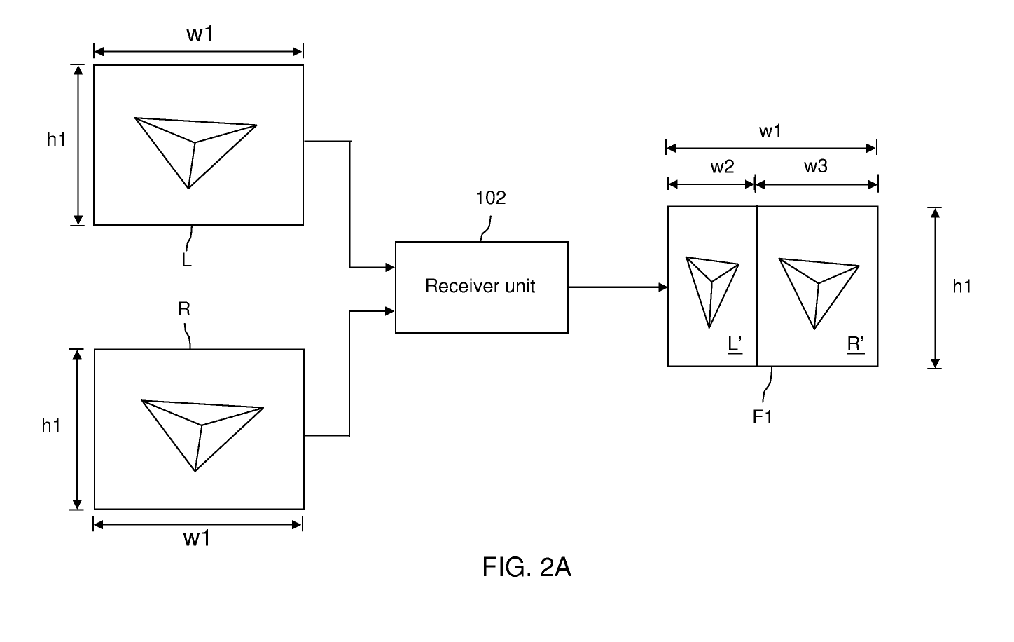

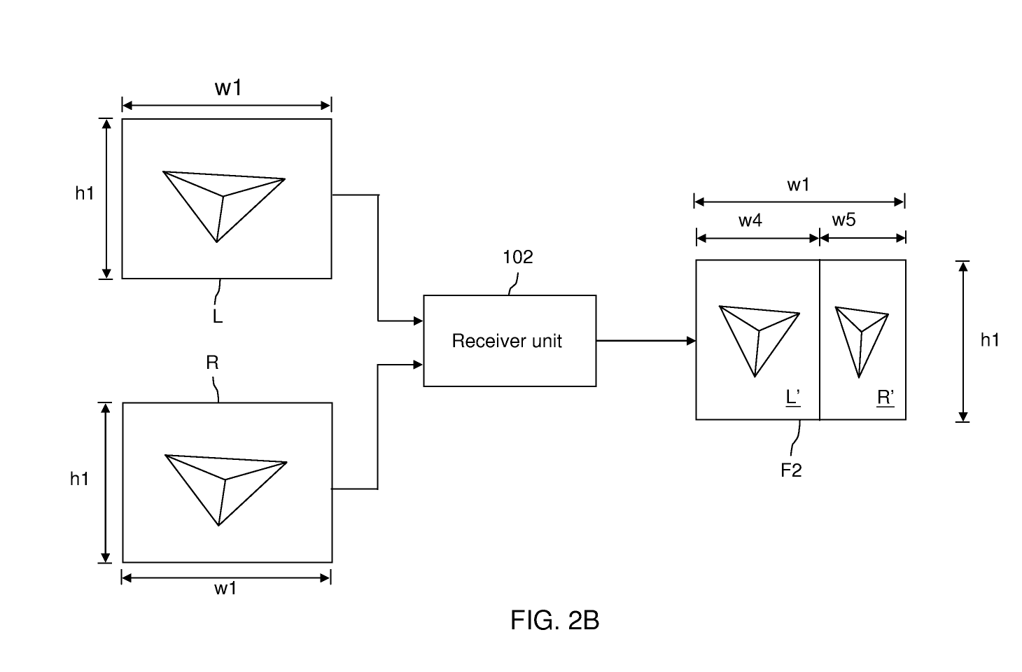

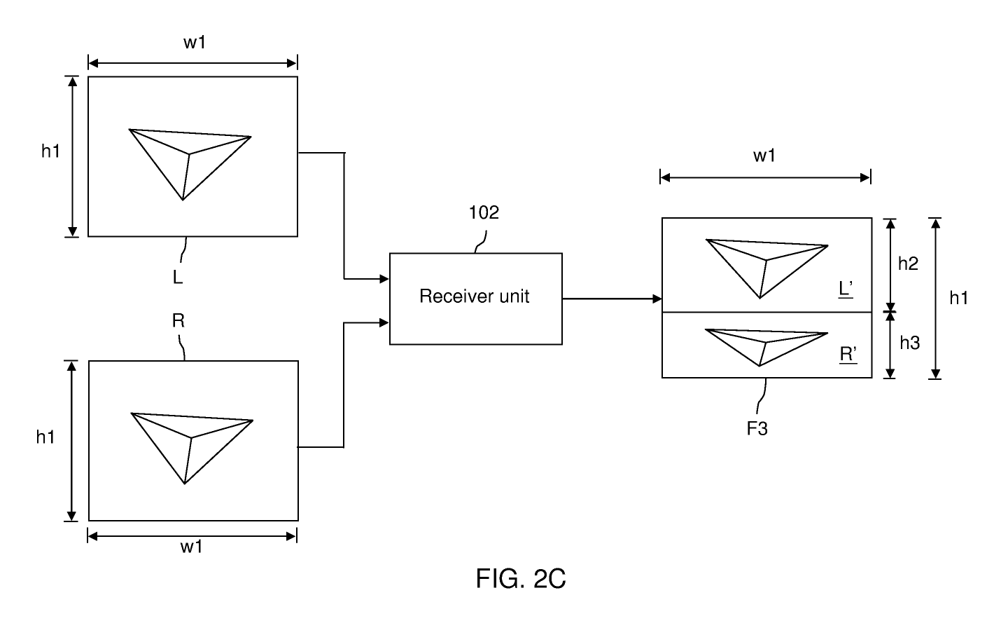

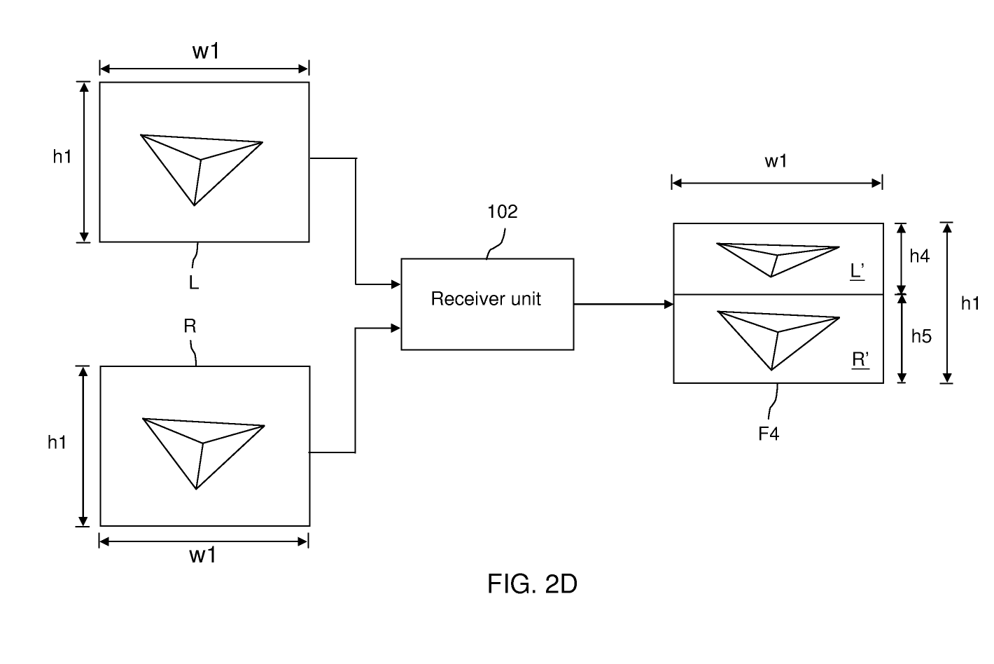

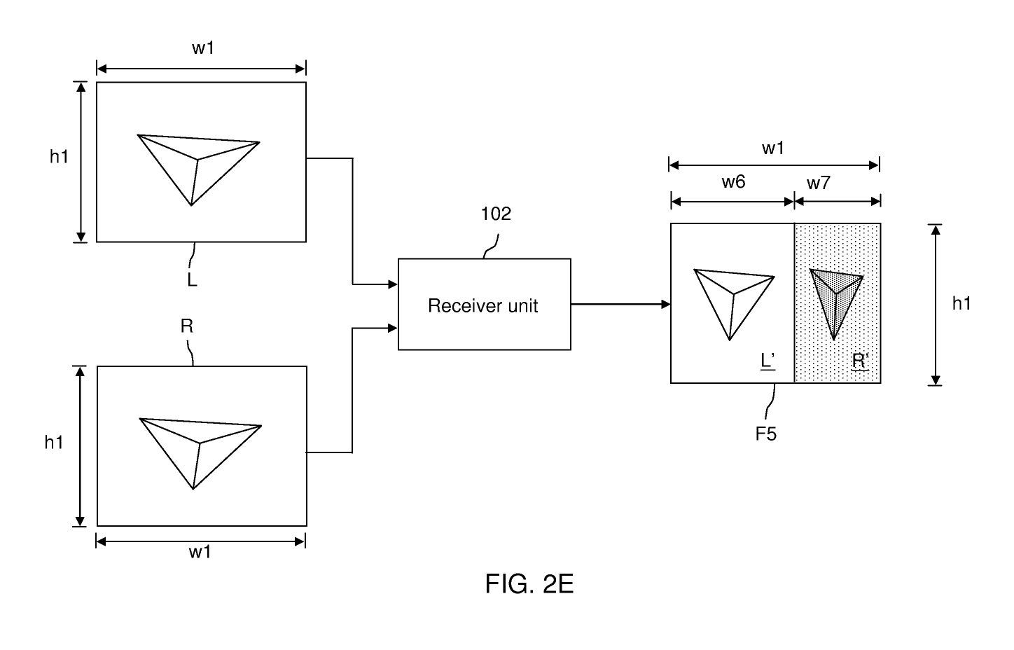

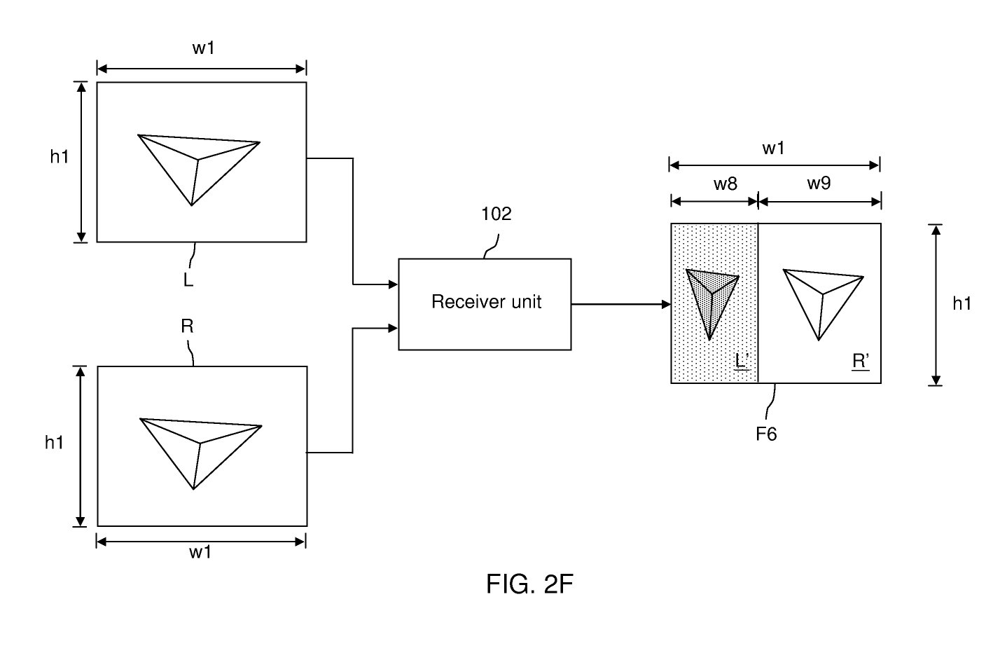

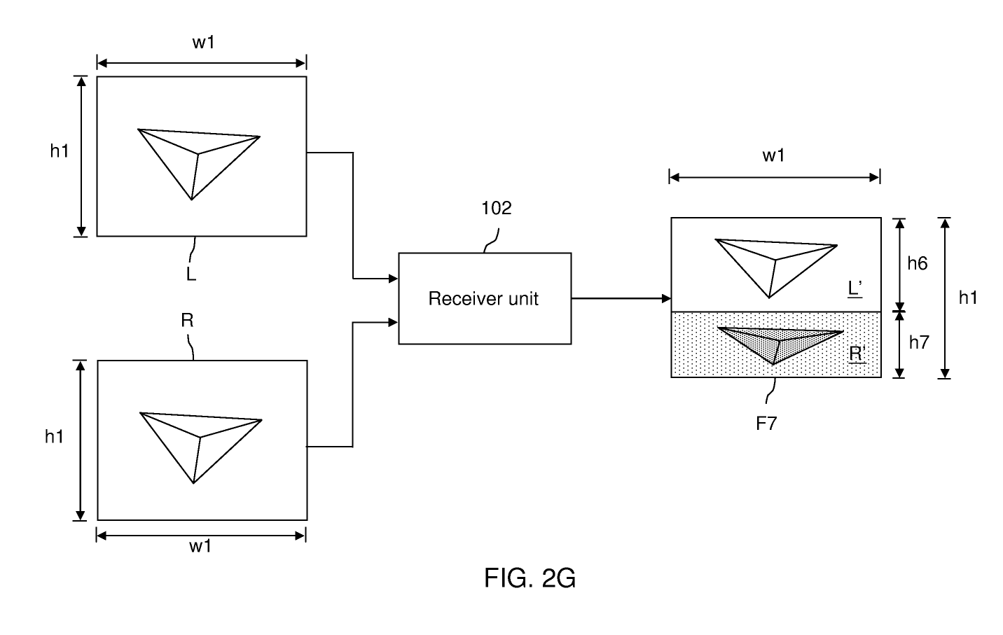

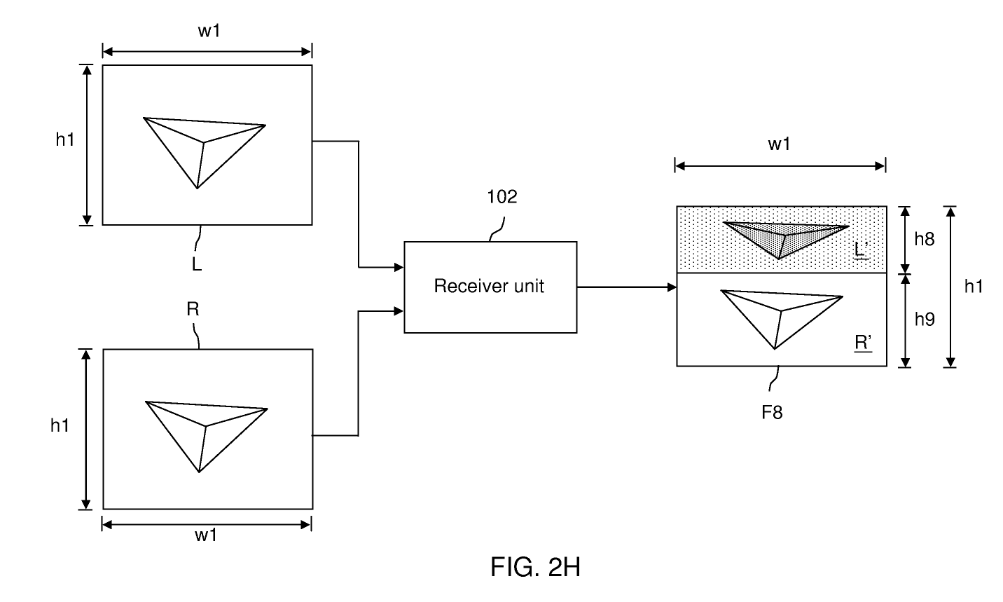

FIGS. 2A through 2E are schematic diagrams illustrating different formats of the image frame F that can be generated by the image formatter unit 102 based on the left-view and right-view images L and R. In the description hereafter, w1, w2 . . . w8 represent different horizontal pixel sizes (i.e., number of pixels in the horizontal direction), and h1, h2 . . . h8 represent different vertical pixel sizes (i.e., number of pixels in the vertical direction). In FIG. 2A, suppose that the inputted left-view image L and right-view image R respectively have a same pixel resolution r1=w1×h1. In one embodiment, w1 can be exemplary equal to 1920 pixels, and h1 is equal to 1080 pixels. The image formatter unit 102 can scale down the left-view image L to form a compressed left-view image L′ of a pixel resolution r2=w2×h1, scale down the right-view image R to form a compressed right-view image R′ of a pixel resolution r3=w3×h1 different from the pixel resolution r1, and assemble the compressed images L′ and R′ horizontally side-by-side into an image frame F1. The left-view and right-view images L and R can be scaled down with different compression ratios (defined as the ratio of the compressed size to the uncompressed size). In FIG. 2A, the horizontal compression ratio applied on the left-view image L is smaller than that applied on the right-view image R, such that the horizontal pixel size w2 of the compressed left-view image L′ is smaller than the horizontal pixel size w3 of the compressed right-view image R′, e.g., w2=⅓×w1 and w3=⅔×w1. Accordingly, the resulting side-by-side horizontal format of the image frame F1 can have a pixel size that is equal to that of the initial images L and R (i.e., w1=w2+w3), and include a compressed left-view image L′ that has a pixel resolution r2 smaller than the pixel resolution r3 of the compressed right-view image R′.

FIG. 2B illustrates a second format of an image frame F2 that can be generated by the image formatter unit 102. Likewise, the inputted left-view image L and right-view image R can respectively have a same pixel resolution r1=w1×h1. The image formatter unit 102 can scale down the left-view image L to form a compressed left-view image L′ of a pixel resolution r4=w4×h1, scale down the right-view image R to form a compressed right-view image R′ of a pixel resolution r5=w5×h1 different from the pixel resolution r4, and assemble the compressed images L′ and R′ horizontally side-by-side into an image frame F2. In this case, the horizontal compression ratio applied on the left-view image L is greater than that applied on the right-view image R, such that the horizontal pixel size w4 of the compressed left-view image L′ is greater than the horizontal pixel size w5 of the compressed right-view image R′, e.g., w4=⅔×w1 and w5=⅓×w1. Accordingly, the resulting side-by-side horizontal format of the image frame F2 can have a pixel size that is equal to that of the initial images L and R (i.e., w1=w4+w5), and include a compressed right-view image R′ that has a pixel resolution r5 smaller than the pixel resolution r4 of the compressed left-view image L′.

FIG. 2C illustrates a third format of an image frame F3 that can be generated by the image formatter unit 102. The inputted left-view image L and right-view image R can respectively have a same pixel resolution r1=w1×h1. The image formatter unit 102 can scale down the left-view image L to form a compressed left-view image L′ of a pixel resolution r6=w1×h2, scale down the right-view image R to form a compressed right-view image R′ of a pixel resolution r7=w1×h3 different from the pixel resolution r6, and assemble the compressed images L′ and R′ vertically adjacent to each other into an image frame F3. In this case, the vertical compression ratio applied on the left-view image L is greater than that applied on the right-view image R, such that the vertical pixel size h2 of the compressed left-view image L′ is greater than the vertical pixel size h3 of the compressed right-view image R′, e.g., h2=⅔×h1 and h3=⅓×h1. Accordingly, the resulting top-bottom format of the image frame F3 can have a pixel size that is equal to that of the initial images L and R (i.e., h1=h2+h3), and include a compressed right-view image R′ that has the pixel resolution r7 smaller than the pixel resolution r6 of the compressed left-view image L′.

FIG. 2D illustrates a fourth format of an image frame F4 that can be generated by the image formatter unit 102. The image formatter unit 102 can scale down the left-view image L to form a compressed left-view image L′ of a pixel resolution r8=w1×h4, scale down the right-view image R to form a compressed right-view image R′ of a pixel resolution r9=w1×h5 different from the pixel resolution r8, and assemble the compressed images L′ and R′ vertically adjacent to each other into an image frame F4. In this case, the vertical compression ratio applied on the left-view image L is smaller than that applied on the right-view image R, e.g., h4=⅓×h1 and h5=⅔×h1. Accordingly, the resulting top-bottom format of the image frame F4 can have a pixel size that is equal to that of the initial images L and R (i.e., h1=h4+h5), and include a compressed left-view image L′ that has the pixel resolution r8 smaller than the pixel resolution r9 of the compressed right-view image R′.

FIG. 2E illustrates a fifth format of an image frame F5 that can be generated by the image formatter unit 102. Suppose that the left-view image L and the right-view image R are color images respectively having a same pixel resolution r1=w1×h1. The image formatter unit 102 can scale down the left-view image L to form a compressed left-view image L′ of a pixel resolution r10=w6×h1, scale down the right-view image R to form a compressed right-view image R′ of a pixel resolution r11=w7×h1 that is smaller than the pixel resolution r10, convert the compressed right-view image R′ to a different color format, and assemble the compressed images L′ and R′ horizontally side-by-side into an image frame F5. In this case, the compressed right-view image R′ of the smaller pixel resolution r11 can be converted to a color format that is defined with a smaller quantity of data. For example, suppose that the left-view and right view images L and R are defined with a RGB (Red-Green-Blue) color format that requires 24-bits information (8 bits for each component R, G and B in one pixel). The compressed left-view image L′ can have the same RGB color format, whereas the compressed right-view image R′ can be converted to a grayscale format with 8-bits information. Accordingly, the resulting side-by-side horizontal format of the image frame F5 can have a pixel size that is equal to that of the initial images L and R, and include a compressed right-view image R′ of smaller pixel resolution r11 that is converted to a color format smaller than that of the initial images L and R. It is understood that the foregoing color formats have been described as examples, and other color formats may be applicable.

FIG. 2F illustrates a sixth format of an image frame F6 that can be generated by the image formatter unit 102. According to this side-by-side horizontal format, the compressed left-view image L′ has a pixel resolution r12=w8×h1, the compressed right-view image R′ has a pixel resolution r13=w9×h1 that is greater than the pixel resolution r12, and the image frame F6 can have a pixel size that is equal to that of the initial images L and R (i.e., w1=w8+w9). Moreover, the compressed left-view image L′ of the smaller pixel resolution r12 can be converted to a smaller color format (e.g., grayscale), whereas the right-view image R′ can keep the initial color format (e.g., RGB format).

FIG. 2G illustrates a seventh format of an image frame F7 that can be generated by the image formatter unit 102. Likewise, the inputted left-view image L and right-view image R can be color images respectively having a same pixel resolution r1=w1×h1. The image formatter unit 102 can scale down the left-view image L to form a compressed left-view image L′ of a pixel resolution r14=w1×h6, scale down the right-view image R to form a compressed right-view image R′ of a pixel resolution r15=w1×h7 smaller than the pixel resolution r14, convert the compressed right-view image R′ to a different color format (e.g., grayscale format), and assemble the compressed images L′ and R′ vertically adjacent to each other into an image frame F7. The resulting top-bottom format of the image frame F7 can have a pixel size that is equal to that of the initial images L and R (i.e., h1=h6+h7), and include a compressed right-view image R′ of the smaller pixel resolution r15 that is converted to a color format smaller than that of the initial images L and R.

FIG. 2H illustrates an eighth format of an image frame F8 that can be generated by the image formatter unit 102. According to this top-bottom format, the compressed left-view image L′ has a pixel resolution r16=w1×h8, the compressed right-view image R′ has a pixel resolution r17=w1×h9 greater than the pixel resolution r16, and the image frame F8 can have a pixel size that is equal to that of the initial images L and R (i.e., h1=h8+h9). Moreover, the compressed left-view image L′ of the smaller pixel resolution r16 can be converted to a smaller color format (e.g., grayscale), whereas the compressed right-view image R′ can keep the initial color format (e.g., RGB format).

By applying any of the aforementioned formats, the image formatter unit 102 can compress and assemble the inputted left-view and right-view images into an image frame that can be transmitted through a limited bandwidth to the image processing unit 104. The image processing unit 104 can then retrieve the left-view and right-view images L′ and R′ from the image frame F, and process the left-view and right-view images L′ and R′ to form the stereoscopic pair of left-view and right-view images Lᵥ and Rᵥ to be shown on the display device 108.

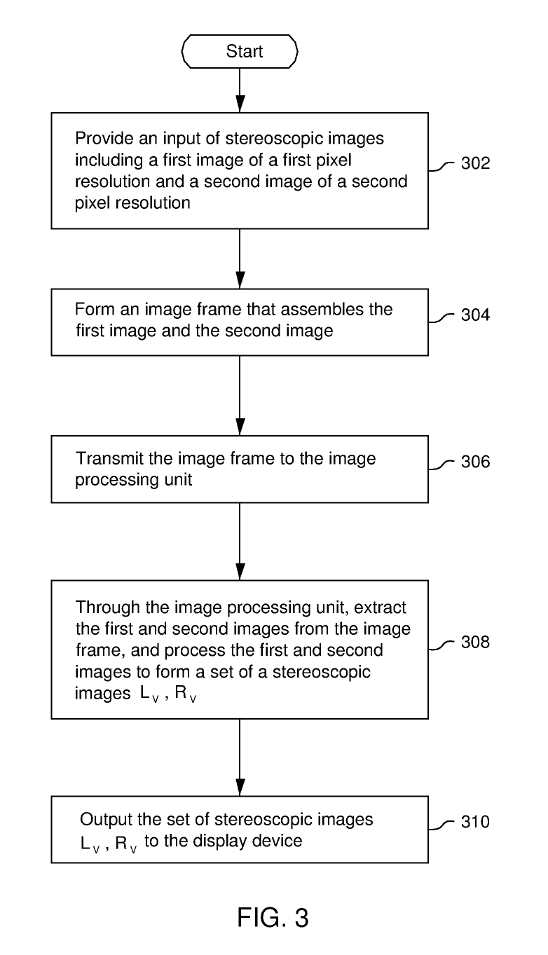

In conjunction with FIGS. 2A through 2H, FIG. 3 is a flowchart of method steps for generating a stereoscopic image according to an embodiment of the present invention. In step 302, a pair of stereoscopic left-view and right-view images L′ and R′ with different resolutions is provided. The left-view and right-view images L′ and R′ can respectively represent a same scene from left-eye and right-eye perspectives. As described previously, the image formatter unit 102 can generate the left-view and right-view images L′ and R′ by compressing the inputted left-view and right-view images L and R with different compression ratios. In alternate embodiments, the stereoscopic pair of left-view and right-view images L′ and R′ can also be directly inputted to the image formatter unit 102 from two distinct cameras of different resolutions, such that no compression is required.

In step 304, the image formatter unit 102 then can assemble the left-view and right-view images L′ and R′ according to a side-by-side horizontal format or top-bottom format to generate an image frame F. Any of the formats described previously with reference to FIGS. 2A through 2H may be used to form the image frame F. In step 306, the image formatter unit 102 can transmit the image frame F to the image processing unit 104.

In step 308, the image processing unit 104 can extract the left-view and right-view images L′ and R′ from the image frame F, and process the left-view and right-view images L′ and R′ to form the pair of stereoscopic left-view and right-view images Lᵥ and Rᵥ to be shown on the display device 108. In one embodiment, the image processing unit 104 can performs various operations including, without limitation, scaling up and/or interpolating the extracted images L′ and R′, constructing depth maps, and the like. In step 310, the left-view and right-view images Lᵥ and Rᵥ then can be outputted to the display device 108.

In the method described above, the image frame F can be assembled from left-view and right-view images of different pixel resolutions according to one predetermined format, such as any of the formats shown in FIGS. 2A through 2H. The use of different pixel resolutions for the compressed images can suitably conform with the viewer's eye dominance (i.e., the tendency to prefer visual input from one eye to the other), e.g., the compressed image associated with the dominant eye may be set with the higher pixel resolution. In this manner, depth perception is less affected by image compression. In alternate embodiments, a method can also be provided to allow selecting a proper format for the image frame F according to desirable depth perception of the viewer as described hereafter.

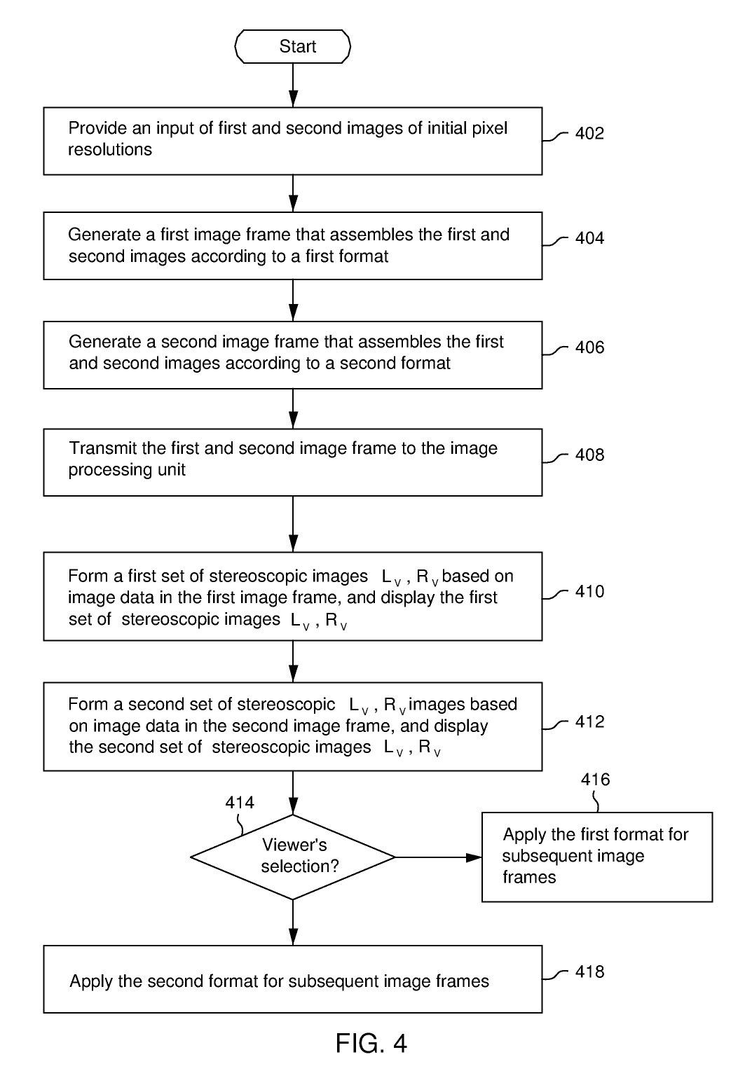

FIG. 4 is a flowchart of method steps for generating stereoscopic images according to another embodiment of the present invention. In step 402, a pair of inputted left-view and right-view images L and R of a same initial resolution are provided to the image formatter unit 102 from an image source device. The left-view and right-view images L and R can be stereoscopic images respectively representing a same scene from left-eye and right-eye perspectives. In step 404, the image formatter unit 102 can process the inputted left-view and right-view images L and R to generate a first image frame according to a first format. For example, the image formatter unit 102 can scale down the left-view image L from the initial pixel resolution r1 to the second pixel resolution r2=w2×h1 to form the compressed left-view image L′, scale down the right-view image R from the initial pixel resolution r1 to the third pixel resolution r3=w3×h1 to form the compressed right-view image R′, and then assemble the compressed left-view and right-view images L′ and R′ to form the image frame F1, as shown in FIG. 2A. With this first format, the pixel resolution of the compressed left-view image L′ is smaller than that of the compressed right-view image R′.

In step 406, the image formatter unit 102 can process the inputted left-view and right-view images L and R to generate a second image frame according to a second format. For example, the image formatter unit 102 can scale down the left-view image L from the initial pixel resolution r1 to a fourth pixel resolution r4=w4×h1 to form a compressed left-view image L′, scale down the right-view image R from the initial pixel resolution r1 to a fifth pixel resolution r5=w5×h1 to form a compressed right-view image R′, and then assemble the compressed left-view and right-view images L′ and R′ to form the image frame F2, as shown in FIG. 2B. With this second format, the pixel resolution of the compressed left-view image L′ can be greater than that of the compressed right-view image R′.

It will be understood any of the formats described herein may be applicable to form the first and second image frames. For example, the first image frame can be assembled according to the format of the image frame F3 shown in FIG. 2C, and the second image frame may be formed according to the format of the image frame F4 shown in FIG. 2D (or vice versa). In case the first image frame is assembled according to the format of the image frame F5 shown in FIG. 2E, the second image frame may be formed according to the format of the image frame F6 shown in FIG. 2F. Should the first image frame be assembled according to the format of the image frame F7 shown in FIG. 2G, the second image frame can be assembled according to the format of the image frame F8 shown in FIG. 2H.

In step 408, the image formatter unit 102 can transmit the first and second image frames to the image processing unit 104. The first and second image frames can be transmitted sequentially or in parallel.

In step 410, the image processing unit 104 can extract the left-view and right-view images L′ and R′ from the first image frame, and process the left-view and right-view images to synthesize a first stereoscopic pair of left-view and right-view images Lᵥ₁ and Rᵥ₁ that can be shown on the display device 108.

In step 412, the image processing unit 104 can retrieve the left-view and right-view images L′ and R′ from the second image frame, and synthesize a second stereoscopic pair of left-view and right-view images Lᵥ₂ and Rᵥ₂ that can be shown on the display device 108.

In step 414, a graphic user interface can be sent from the user interface unit 106 to the image processing unit 104 to be shown on the display device 108. The graphic user interface can request a viewer's selection of whether depth perception is rendered in a better manner with the first stereoscopic pair of left-view and right-view images Lᵥ₁ and Rᵥ₁ or the second stereoscopic pair of left-view and right-view images Lᵥ₂ and Rᵥ₂. The viewer's selection may depend on the eye dominance. For example, suppose that the compressed left-view image L′ has a higher resolution than the compressed right-view image R′ in the first image frame, and the compressed left-view image L′ conversely has a lower resolution than the compressed right-view image R′ in the second image frame. A viewer with left eye dominance will likely select the first stereoscopic pair of left-view and right-view images Lᵥ₁ and Rᵥ₁ that is generated from the image data conveyed through the first image frame, because the pixel resolution of the compressed left-view image is higher than the pixel resolution of the right-view image in the first image frame. In contrast, a viewer with right eye dominance will likely select the second stereoscopic pair of left-view and right-view images Lᵥ₂ and Rᵥ₂ that is generated from the image data conveyed through the second image frame, because the pixel resolution of the compressed right-view image is higher than the pixel resolution of the compressed left-view image in the second image frame. Accordingly, the viewer's selection can allow to set the proper format for next image frames F that are assembled by the image formatter unit 102 and transmitted to the image processing unit 104.

In case the viewer selects the first stereoscopic pair of left-view and right-view images Lᵥ₁ and Rᵥ₁ via the input unit 110, the image formatter unit 102 in step 416 can apply the first format for generating subsequent image frames. If the viewer selects the second stereoscopic pair of left-view and right-view images Lᵥ₂ and Rᵥ₂, the image formatter unit 102 in step 418 can apply the second format for generating subsequent image frames.

At least one advantage of the systems and methods described herein is the ability to transmit image frames that can assemble inputted left-view and right-view images of different pixel resolutions. The proper format of the image frames can be selected according to the eye dominance of the viewer, so that depth perception is unaffected by the compression of the stereoscopic pairs of images.

The foregoing description of embodiments has provided multiple examples of devices and methods including multiple functions and operations. It can be appreciated that certain of these functions and operations, either partly or in whole, can be implemented by hardware, software, firmware and any combinations thereof.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A method of rendering stereoscopic images, comprising:
providing a first image of a scene having a first pixel resolution, and a second image of the same scene having a second pixel resolution different from the first pixel resolution;
forming a first image frame that assembles the first image of the first pixel resolution with the second image of the second pixel resolution; and
transmitting the first image frame to an image processing unit.

2. The method according to claim 1, wherein the step of providing the first image of the first pixel resolution and the second image of the second pixel resolution comprises:
receiving the first and second images of the same scene respectively with a same initial pixel resolution;
scaling down the first image from the initial pixel resolution to the first pixel resolution; and
scaling down the second image from the initial pixel resolution to the second pixel resolution.

3. The method according to claim 2, further comprising:
scaling down the first image from the initial pixel resolution to a third pixel resolution;
scaling down the second image from the initial pixel resolution to a fourth pixel resolution, wherein the third pixel resolution differs from the first pixel resolution, and the fourth pixel resolution differs from the second pixel resolution;
forming a second image frame that assembles the first image of the third pixel resolution and the second image of the fourth pixel resolution; and
transmitting the second image frame to the image processing unit.

4. The method according to claim 3, wherein the first pixel resolution of the first image is greater than the second pixel resolution of the second image, and the third pixel resolution of the first image is smaller than the fourth pixel resolution of the second image.

5. The method according to claim 4, wherein the first image frame assembles the first and second images according to a first format, the second image frame assembles the first and second images according to a second format, and the method further comprising:
extracting image data from the first image frame to generate a first set of stereoscopic images, and displaying the first set of stereoscopic images;
extracting image data from the second image frame to generate a second set of stereoscopic images, and displaying the second set of stereoscopic images;
requesting a viewer's selection based on a depth perception of the displayed first and second sets of stereoscopic images; and
in response to the viewer's selection, applying either of the first and second format to generate a plurality of subsequent image frames.

6. The method according to claim 1, wherein the first image corresponds to a left-eye image, and the second image corresponds to a right-eye image.

7. The method according to claim 1, wherein the first pixel resolution is greater than the second pixel resolution, and the first image is associated with a dominant eye.

8. The method according to claim 1, wherein the step of forming the first image frame includes arranging the first and second images horizontally side-by-side in the first image frame.

9. The method according to claim 1, wherein the step of forming the first image frame includes arranging the first and second images adjacently one above the other in the first image frame.

10. The method according to claim 1, wherein the first and second images assembled in the first image frame have different color formats.

11. The method according to claim 10, wherein the first pixel resolution is greater than the second pixel resolution, the first image assembled in the first image frame has a color format, and the second image assembled in the first image frame has a grayscale format.

12. A system of rendering stereoscopic images, comprising:
a memory; and
a processing unit configured to
receive a first image and a second image of a same scene respectively at a same initial pixel resolution;
scale down the first image from the initial pixel resolution to a first pixel resolution;
scale down the second image from the initial pixel resolution to a second pixel resolution different from the first pixel resolution;
generate a first image frame that assembles the first image of the first pixel resolution with the second image of the second pixel resolution; and
process image data contained in the first image frame to form a first set of stereoscopic images.

13. The system according to claim 12, wherein the processing unit is further configured to
scale down the first image from the initial pixel resolution to a third pixel resolution;
scale down the second image from the initial pixel resolution to a fourth pixel resolution, wherein the third pixel resolution differs from the first pixel resolution, and the fourth pixel resolution differs from the second pixel resolution;
forming a second image frame that includes the first image of the third pixel resolution with the second image of the fourth pixel resolution; and
process image data contained in the second image frame to form a second set of stereoscopic images.

14. The system according to claim 13, wherein the first pixel resolution of the first image is greater than the second pixel resolution of the second image, and the third pixel resolution of the first image is smaller than the fourth pixel resolution of the second image.

15. The system according to claim 14, wherein the first image frame assembles the first and second images according to a first format, and the second image frame assembles the first and second images according to a second format, and the system further comprising a display device connected with the processing unit, the processing unit being further configured to:
have the first and second sets of stereoscopic images displayed on the display device;
request a viewer's selection based on a depth perception of the displayed first and second sets of stereoscopic images; and
in response to the viewer's selection, applying either of the first and second format to generate a plurality of subsequent image frames.

16. The system according to claim 12, wherein the first image corresponds to a left-eye image, and the second image corresponds to a right-eye image.

17. The system according to claim 12, wherein the first pixel resolution is higher than the second resolution, and the first image is associated with a dominant eye.

18. The system according to claim 12, wherein the processing unit is configured to form the first image frame by arranging the first and second images horizontally side-by-side in the first image frame.

19. The system according to claim 12, wherein the processing unit is configured to form the first image frame by arranging the first and second images one above the other in the first image frame.

20. The system according to claim 12, wherein the first pixel resolution is greater than the second pixel resolution, the first image assembled in the first image frame has a color format, and the second image assembled in the first image frame has a grayscale format.
